(19) United States
(12) Patent Application Publication
(10) Pub. No.: US 2026/0215987 A1
(43) Pub. Date: Jul. 30, 2026

(54) ELEVATION ADJUSTABLE HEAD SECTION FOR A TREATMENT TABLE

(71) Applicant: Cardon Rehabilitation & Medical Equipment Ltd., Burlington (CA)

(72) Inventor: Mardig Sevadjian, Oakville (CA)

(21) Appl. No.: 19/037,718

(22) Filed: Jan. 27, 2025

(51) Int. Cl. A61G 13/12

(52) U.S. Cl. CPC A61G 13/121; A61G 13/1295

(57) ABSTRACT

The present invention is an elevation adjustable head section for a treatment table. The elevation adjustable head section comprises an upper frame connected at a hinged end of the upper frame to a hinged end of a lower frame by a hinge, and wherein an unhinged end of the upper frame is movable away from an unhinged end of the lower frame. An adjusting bar attached to the upper frame may be the means to set how far the unhinged end of the upper frame is away from the unhinged end of the lower frame. The present invention further comprises the elevation adjustable head section attached to a treatment table with a tilting mechanism to tilt the elevation adjustable head section.

### FIELD OF THE INVENTION

The invention relates generally to a treatment table, and specifically to an elevation adjustable head section for a treatment table.

### BACKGROUND OF THE INVENTION

Treatment tables are used with individuals of different sizes and for individuals outside of the average size it may be difficult to maintain proper alignment and for treatment to be comfortable for the individual. Treatment tables have been adapted to comprise sections. There are several types of adjustable treatment tables, for example, as described in US Patent Nos. 8,672,971 and 7,189,214, there are adjustable treatment tables with three sections in which the head section is smaller than the other two sections.

The head section on a sectional treatment table is generally the smallest section; however, this section is very important since it supports the head, and proper alignment of the head, neck and body is important.

Treatment tables with a tilting head section are known. For example, in US Patent Application No. 14/949,250 filed November 23, 2015, a treatment table is described with a head section that tilts up with the tilting mechanism shown in FIG. 4 therein. For an individual with a thick/large chest lying prone on the table with the head section in neutral position, their head will be falling forward, and lying on their back, their head will be arching back. For such an individual in prone position or on their back, tilting the head section will raise their head up at an angle and not be comfortable.

It is desirable to have a treatment table with an elevation adjustable head section which improves comfort and alignment of the head, neck and body.

### SUMMARY OF THE INVENTION

In accordance with one aspect of the invention, there is an elevating head section for a treatment table comprising an upper frame connected at a hinged end of the upper frame to a hinged end of a lower frame by a hinge, and wherein an unhinged end of the upper frame is movable away from an unhinged end of the lower frame with adjusting means to set how far the unhinged end of the upper frame is away from the unhinged end of the lower frame.

The elevation adjustable head section may additionally comprise a head pad which may be removable or permanently attached.

The adjusting means may be an adjusting bar attached to the upper frame.

The elevation adjustable head section may additionally comprise a spring-loaded pin, and additionally comprise an adjusting bar holder attached to the lower frame, which adjusting bar holder has an adjusting bar hole, and wherein the adjusting bar comprises a plurality of adjusting bar holes, and wherein when one of the plurality of the adjusting bar holes is lined up with the adjusting bar holder hole, the spring-loaded pin may be inserted to set how far the unhinged end of the upper frame is away from the unhinged end of the lower frame.

The lower frame may be attached to a tilting mechanism on the treatment table which tilting mechanism is capable of tilting the hinged end of the lower frame towards the treatment table.

The lower frame may be additionally pivotably attached to the treatment table.

The unhinged end of the lower frame may be pivotably attached to a treatment table and the lower frame may be additionally attached to a tilting mechanism on the treatment table capable of tilting the hinged end of the lower frame towards the treatment table.

The elevation adjustable head section may comprise a hinge comprised on each side of an outer pivot bar attached to the lower frame, an inner pivot bar attached to the upper frame, a bolt which passes through the outer pivot bar and the inner pivot bar, and a nut which secures the bolt.

### DESCRIPTION OF THE DRAWINGS

In the drawings which illustrate by way of example only an embodiment of the invention:

FIG. 1 is a right-side perspective view of an elevation adjustable head section for a treatment table of the present invention in an elevated position.

FIG. 2 is a right-side perspective view of the elevation adjustable head section of FIG. 1 without a head pad.

FIG. 3 is a right-side perspective view of an elevation adjustable head section of FIG. 1 in a neutral position.

FIG. 4 is a right-side perspective view of the elevation adjustable head section of FIG. 3 without a head pad.

FIG. 5 is a close-up left-side perspective view of the elevation adjustable head section of FIG. 2.

FIG. 6 is a close-up perspective view of the elevation adjustable head section of FIG. 5 showing range of motion.

FIG. 7 is a front perspective view of the elevation adjustable head section of FIG. 2.

### DETAILED DESCRIPTION OF THE DRAWINGS

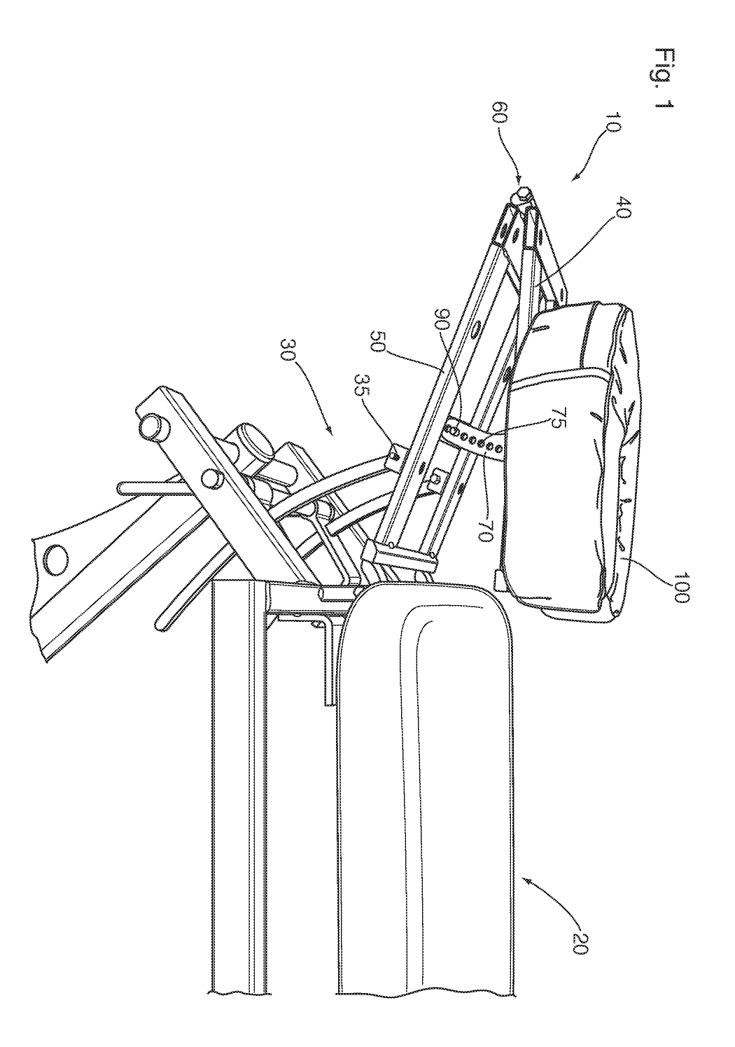

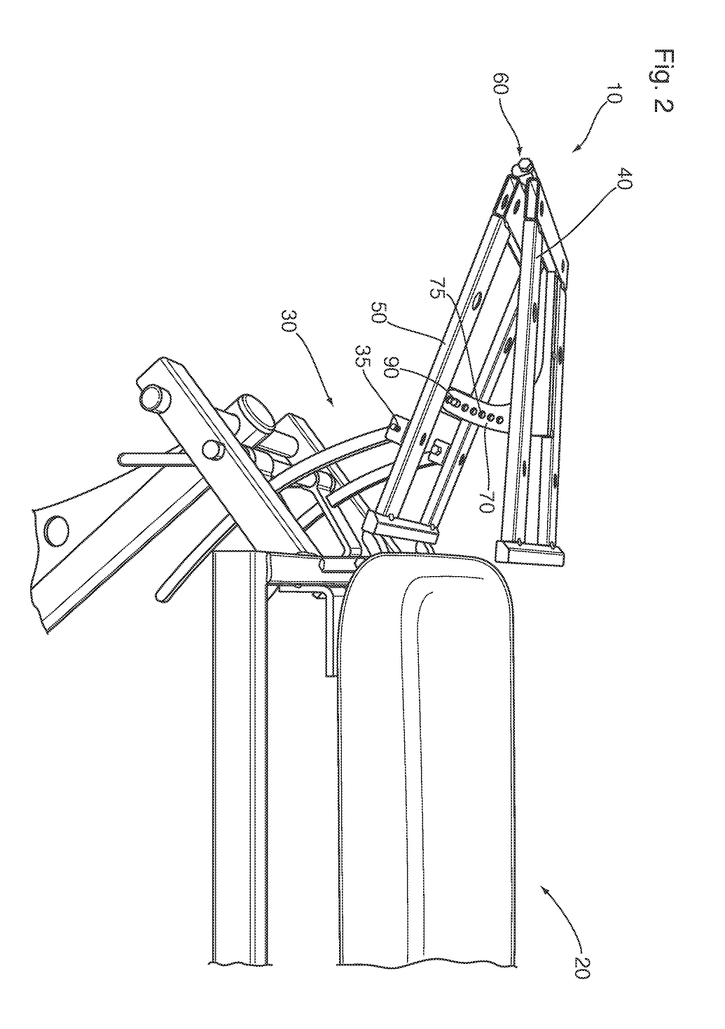

Referring to FIG. 1, an elevation adjustable head section 10 for a treatment table 20 according to an embodiment of the present invention is shown in an elevated position with a head pad 100. FIG. 2 shows the elevation adjustable head section 10 in an elevated position without the head pad 100 shown in FIG. 1.

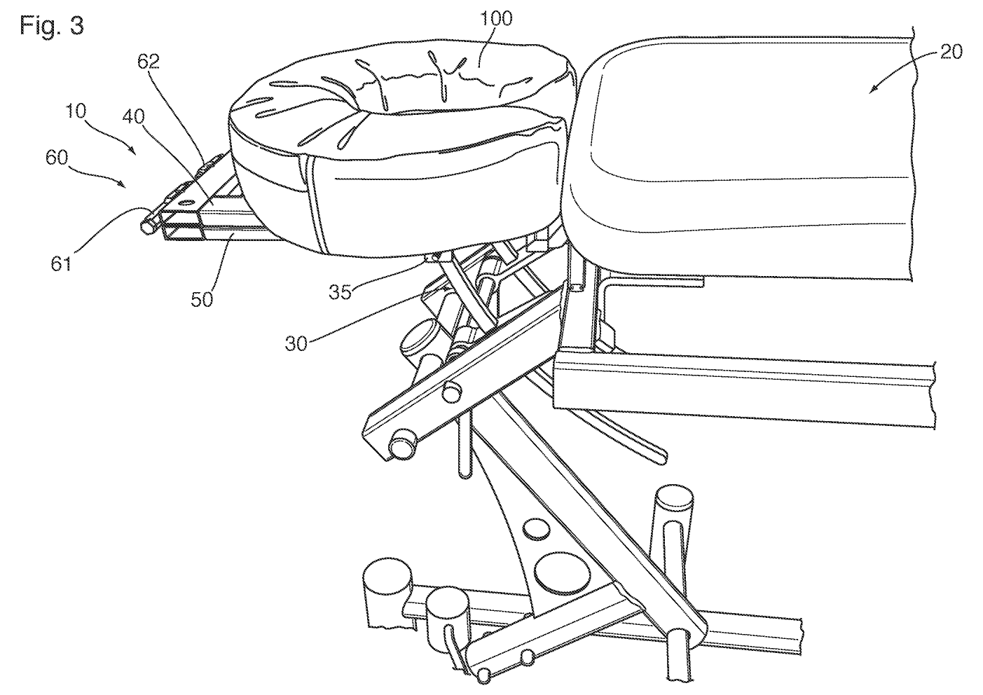

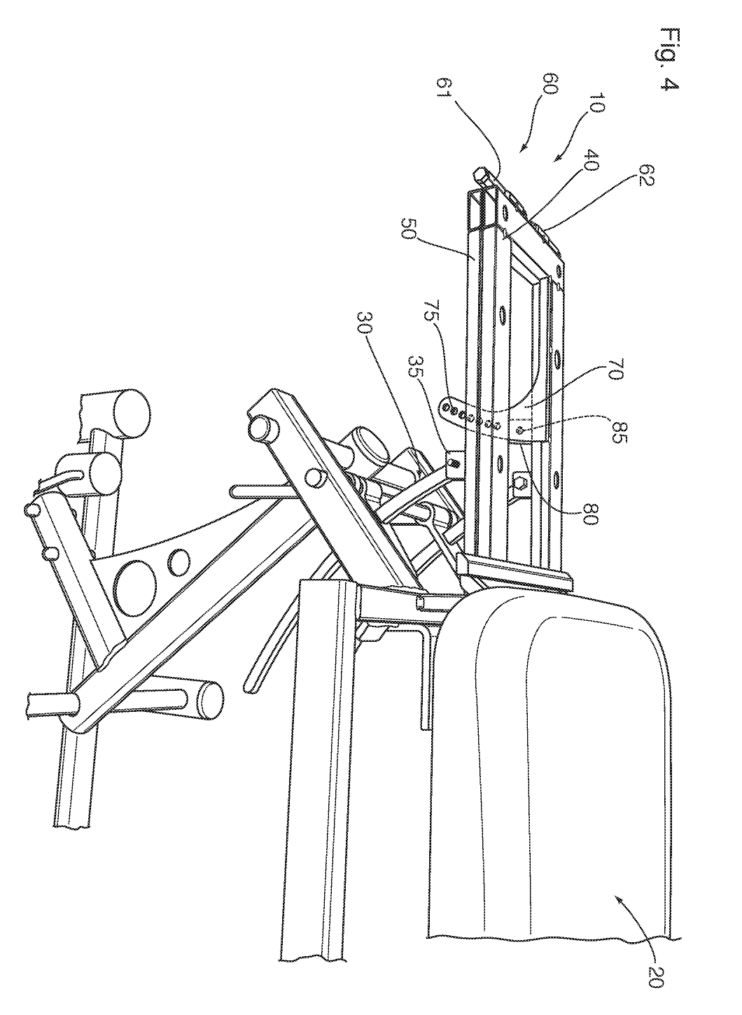

FIG. 3 shows the elevation adjustable head section 10 in a neutral position with a head pad 100. FIG. 4 shows the elevation adjustable head section 10 in a neutral position without the head pad 100 shown in FIG. 3.

As seen in at least FIG. 1, in the present invention of the elevation adjustable head section 10, an upper frame 40 is joined to a lower frame 50 by a hinge 60 at the respective hinged ends of the upper frame 40 and lower frame 50, and an unhinged end of the upper frame 40 is movable away from an unhinged end of the lower frame 50. The degree of movement of the unhinged end of the upper frame 40 from the unhinged end of the lower frame 50 may vary and when chosen by a user can be set. When combined with a treatment bed, the lower frame 50 is attached to a tilting mechanism 30 of a treatment bed 20 and the lower frame 50 may additionally be pivotably attached to the treatment bed 20, for example at the unhinged end, for additional stability. The amount of tilt provided by the tilting mechanism 30 may also be variable and when chosen can be set.

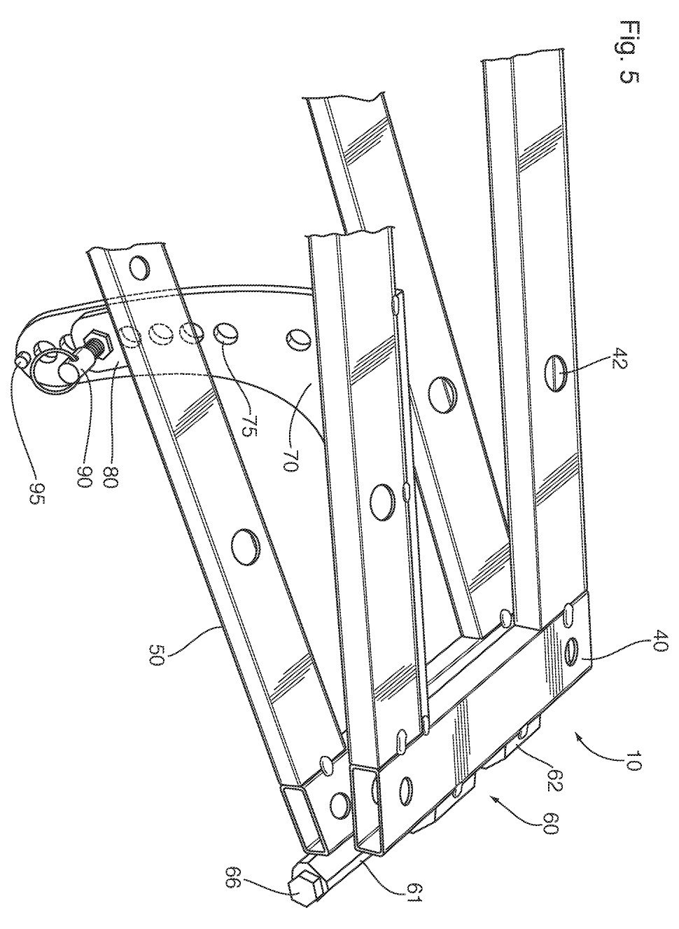

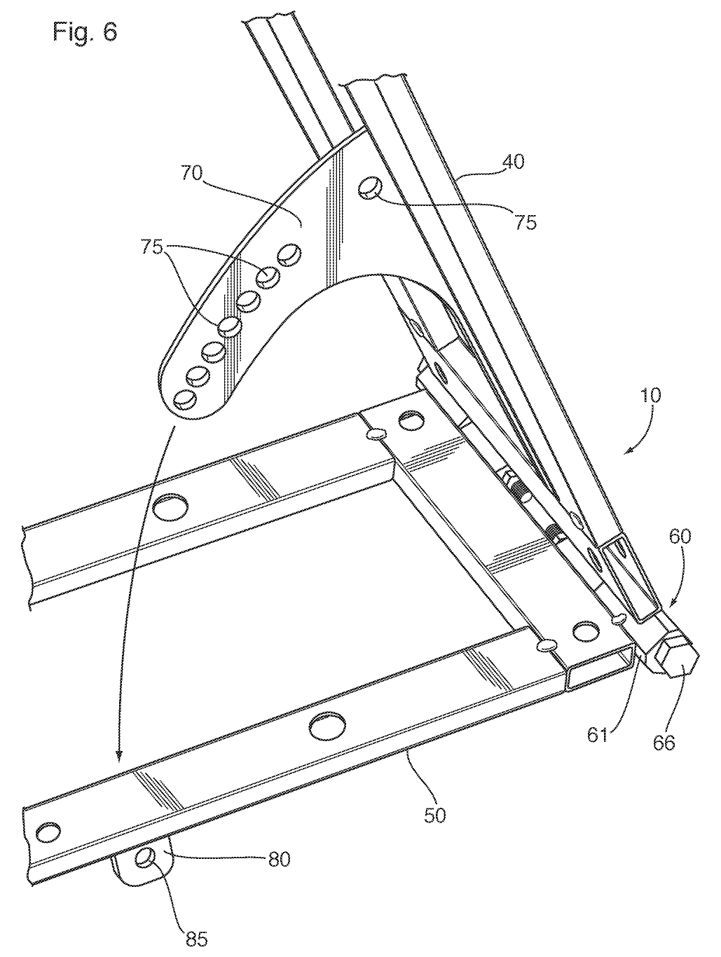

FIGS. 5 and 6 show the components of an embodiment of the elevation adjustable head section 10. In this embodiment an adjusting bar 70 is attached to the upper frame 40 and has a plurality of adjusting bar holes 75, and an adjusting bar holder 80, with an adjusting bar holder hole 85, is attached to the lower frame 50. One of the adjusting bar holes 75 of the adjusting bar 70 is lined up with the adjusting bar holder hole 85 and a spring-loaded knob 90 (see FIGS. 1, 2 and 5) is inserted which sets the degree of movement of the upper frame 40 relative to the lower frame 50. FIG. 5 shows an upper frame hole 42 for attaching a post from the head pad 100 (not shown) but any means may be used. The head pad 100 is generally used for an individual in prone position and may be switched for a full head pad (not shown) for an individual lying on their back. Alternatively, the head pad 100 could be permanently attached to the elevating head section 10. An optional blocking pin 95 is shown in the adjusting bar hole 75 farthest from the upper frame 40 which prevents the adjusting bar 70 from being raised above the lower frame 50 as shown in FIG. 6 without the blocking pin 95. It will be understood that this is optional and also that this function could be accomplished in other ways, for example, by a horizontal bar at the end of the adjusting bar 70 which would abut the adjusting bar holder 80. It will be understood that the adjusting bar 70 could be larger or smaller and have more or less adjusting bar holes 75.

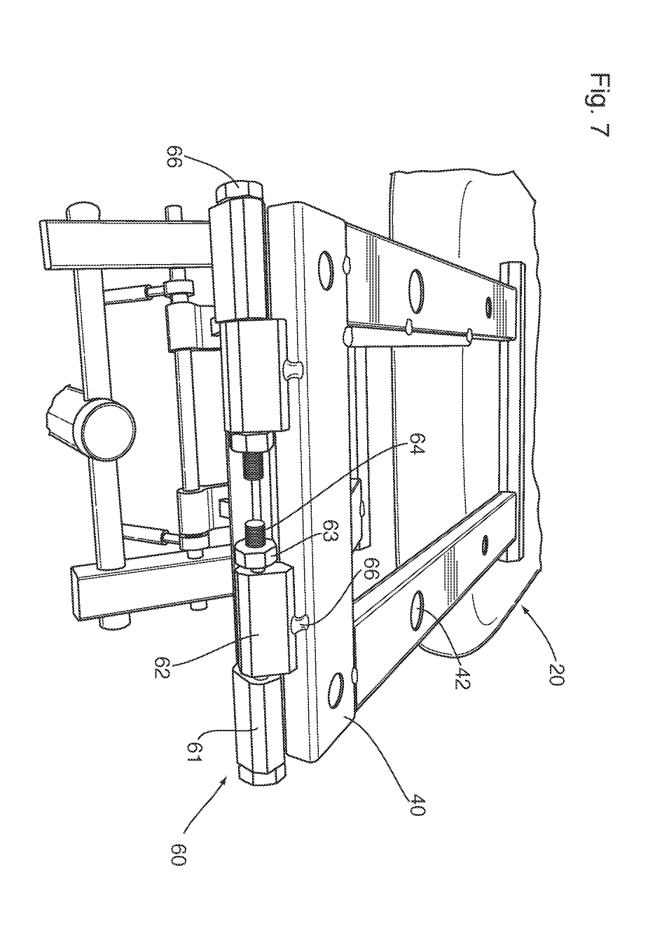

FIG. 7 shows the hinge 60 which may be any configuration that joins the upper frame 40 and the lower frame 50 and allows the upper frame 40 to move relative to the lower frame 50. In this embodiment the hinge 60 is comprised on each side of an upper pivot bar 62 attached (for example by welding) to the upper frame 40 and a lower pivot bar 61 attached to the lower frame 50, each pivot bar 61, 62 having a borehole (not shown) through which a bolt passes which has a bolt head 66 that is bigger than the borehole in the upper pivot bar and ends in a bolt tip 64 on which is secured a nut 63.

As seen in comparison from FIGS. 3 and 4 (in which the elevation adjustable head section is in a neutral position) to FIGS. 1 and 2 (in which the elevation adjustable head section is in an elevated position), the elevation adjustable head section 10 is tilted upwards with any known tilting means 30 which is attached to the elevation adjustable head section 10 by any attachment 35 to tilting mechanism means 30. Tilting mechanisms and tilting means are known in the art, for example as described in US Patent Application No. 14/949,250 filed November 23, 2015, which is incorporated in its entirety.

With reference to FIGS. 1, 3, 5 and 6, in operation, starting from a neutral position in which the spring-loaded pin 90 is in the adjusting bar hole 75 closest to the upper frame 40 (or starting without a spring-loaded pin 90 since the upper frame 40 will rest on the lower frame 50), the elevation adjustable head section 10 is tilted upwards by way of the tilting mechanism 30. The spring-loaded pin 90 is then removed and the unhinged end of the upper frame 40 is raised to the desired level. The adjusting bar hole 75 at that level is lined up with the adjusting bar holder hole 85 and the spring-loaded pin 90 is inserted through both the adjusting bar holder hole 85 and the adjusting bar hole 75.

As can be seen in FIG. 1, the head pad 100 is above the treatment table 20 and a thick/large chested person (not shown) lying prone on the treatment table 20 will have their head, neck and body aligned. As will be understood, the amount the tilting mechanism 30 is raised or lowered and the choice of adjusting bar hole 75 can be customized to determine the right adjustment for an individual.

The invention comprises an elevation adjustable head section 10 as well as an elevation adjustable head section 10 attached to treatment table which has an existing tilting mechanism, and an elevation adjustable head section 10 attached along with a tilting mechanism to a treatment table.

Various embodiments of the present invention having been thus described in detail by way of example, it will be apparent to those skilled in the art that variations and modifications can be made without departing from the invention. The invention includes all such variations and modifications as fall within the scope of the appended claims.

What is claimed is:

1. An elevation adjustable head section for a treatment table comprising an upper frame connected at a hinged end of the upper frame to a hinged end of a lower frame by a hinge, and wherein an unhinged end of the upper frame is movable away from an unhinged end of the lower frame with adjusting means to set how far the unhinged end of the upper frame is away from the unhinged end of the lower frame.

2. The elevation adjustable head section of claim 1, additionally comprising a head pad which may be removable or permanently attached.

3. The elevation adjustable head section of claim 1, in which the adjusting means is an adjusting bar attached to the upper frame.

4. The elevation adjustable head section of claim 3, additionally comprising a head pad which may be removable or permanently attached.

5. The elevation adjustable head section of claim 3, additionally comprising a spring-loaded pin, and additionally comprising an adjusting bar holder attached to the lower frame, which adjusting bar holder has an adjusting bar hole, and wherein the adjusting bar comprises a plurality of adjusting bar holes, and wherein when one of the plurality of the adjusting bar holes is lined up with the adjusting bar holder hole, the spring-loaded pin may be inserted to set how far the unhinged end of the upper frame is away from the unhinged end of the lower frame.

6. The elevation adjustable head section of claim 5, additionally comprising a head pad which may be removable or permanently attached.

7. The elevation adjustable head section of claim 5, wherein the lower frame is attached to a tilting mechanism on the treatment table which tilting mechanism is capable of tilting the hinged end of the lower frame towards the treatment table.

8. The elevation adjustable head section of claim 7, additionally comprising a head pad which may be removable or permanently attached.

9. The elevation adjustable head section of claim 7, wherein the lower frame is additionally pivotably attached to the treatment table.

10. The elevation adjustable head section of claim 9 additionally comprising a head pad which may be removable or permanently attached.

11. The elevation adjustable head section of claim 1, wherein the lower frame is attached to a tilting mechanism on the treatment table capable of tilting the hinged end of the lower frame towards the treatment table.

12. The elevation adjustable head section of claim 11 additionally comprising a head pad which may be removable or permanently attached.

13. The elevation adjustable head section of claim 11, wherein the lower frame is additionally pivotably attached to a treatment table.

14. The elevation adjustable head section of claim 13, additionally comprising a head pad which may be removable or permanently attached.

15. The elevation adjustable head section of claim 3, wherein the lower frame is attached to a tilting mechanism on the treatment table capable of tilting the hinged end of the lower frame towards the treatment table.

16. The elevation adjustable head section of claim 15, additionally comprising a head pad which may be removable or permanently attached.

17. The elevation adjustable head section of claim 15, wherein the lower frame is additionally pivotably attached to a treatment table.

18. The elevation adjustable head section of claim 17, additionally comprising a head pad which may be removable or permanently attached.

19. The elevation adjustable head section of claim 5, wherein the unhinged end of the lower frame is pivotably attached to a treatment table and the lower frame is additionally attached to a tilting mechanism on the treatment table capable of tilting the hinged end of the lower frame towards the treatment table.

20. The elevation adjustable head section of claim 9, wherein the hinge comprises on each side an outer pivot bar attached to the lower frame, an inner pivot bar attached to the upper frame, a bolt which passes through the outer pivot bar and the inner pivot bar, and a nut which secures the bolt.
